(19) United States
(12) Patent Application Publication
(10) Pub. No.: US 2014/0050881 A1
(43) Pub. Date: Feb. 20, 2014

(54) SHEET MATERIAL HAVING FOLDED CONSTRUCTION FOR INHIBITING ITS SEPARATION FROM AHDESIVE TAPE DURING DISPENSING OF THE SAME AND METHODS OF USING AND MAKING THE SAME

(71) Applicant: 3M Inoovative Properties Company, St. Paul, MN (US)

(72) Inventors: Kevin W. Anderson, St. Paul, MN (US); Thomas E. Dewey, JR., Hudson, WI (US); Joseph T. Bartusiak, Osseo, MN (US); Lee A. Thomas, De Pere, WI (US); Russell J. Heyrman, De Pere, WI (US)

(73) Assignee: 3M Inoovative Properties Company, St. Paul, MN (US)

(21) Appl. No.: 14/059,040

(22) Filed: Oct. 21, 2013

Related U.S. Application Data
(63) Continuation of application No. 12/327,242, filed on Dec. 3, 2008.
Application No. 12/327,242 is a continuation-in-part of application No. 12/147,992, filed on Jun. 27, 2008, now abandoned.

(51) Int. Cl. C09J 7/02

(52) U.S. Cl. CPC C09J 7/0207
USPC 428/121

(57) ABSTRACT

Disclosed are folded configurations in coiled sheets enabling formation of masking sheet rolls for improved dispensing and unfolding, in combination, with adhesive tape securable to a walled surface.

### CROSS-REFERENCE TO RELATED PATENT APPLICATION

The present application is a continuation of U.S. patent application Ser. No. 12/327,242 filed Dec. 3, 2008, and entitled “Sheet Material Having Folded Construction For Inhibiting Its Separation From Adhesive Tape During Dispensing Of The Same And Methods of Using and Making The Same”, that is a continuation-in-part application of U.S. patent application Ser. No. 12/147,992, filed Jun. 27, 2008, and entitled “Sheet Material Having Fold Constructions For Use In Masking Tape System”, which applications are incorporated herein by reference and made a part hereof.

### BACKGROUND

The present description is related generally to a coiled sheet material to be used in connection with a pressure sensitive masking tape, and, more particularly, to an improved coiled sheet material having improved fold configurations for inhibiting separation of the sheet material from the tape during dispensing and unfolding of the same.

Masking is one widely used approach for treating a walled surface preparatory to painting or performing other surface treating applications. One known approach joins a pressure sensitive adhesive tape to a folded coiled sheet material as both are dispensed from a dispensing tool. One commercially successful approach for mounting such masking sheet material includes providing a hand held tool, such as described in U.S. Pat. No. 5,113, 921; commonly assigned herewith. Such a sheet dispensing tool includes a frame carrying a roll of the coiled sheet material, and a roll of the pressure sensitive adhesive tape material. In use, a worker simultaneously and continuously applies an adhesive tape to an edge of a folded masking sheet, as both are dispensed, in combination, from the apparatus. This occurs as the hand-held apparatus is drawn along the surface during a masking procedure, whereby the tape mounts a folded masking sheet to the wall surface. Usually, a blade is used for severing the dispensed material. Thereafter, a worker unfolds the masking sheet material so that, when unfolded, it hangs in suspension in juxtaposed and covering relationship to the wall surface. One issue that may arise during unfolding is a worker pulling down and separating the sheet from the tape or the tape from the wall as the sheet is grasped and unfolded. There may be a tendency for this to occur since the adhesive portion of the tape may be less than one inch in width. As such, the worker would have to repeat hanging another masking sheet, not to mention possibly disposing of the pulled down sheet. These constitute significant shortcomings that add to the overall time and costs in performing a masking job.

In one known approach for joining these two rolls, a longitudinally extending lip of the coiled sheet material has a surface joined to the pressure sensitive adhesive tape in a tape application area. It is important that the tape and sheet have a secure connection for dispensing and unfolding. In some examples, the length of the lip is approximately one-quarter of an inch (¼ inch).

Because of the folding configurations of known folded masking sheets of the above kind noted above, such as in the last noted U.S. Patent, supra, pulling forces also are directly applied to a sheet portion directly secured to the pressure sensitive tape. As such, likelihoods exist for separating of the sheet from the adhesive tape or separating the adhesive tape from the wall during the unfolding process as a worker may apply downwardly and with strong forces. Separation leads to a need for the job to be repeated. As a consequence, there are unnecessary repetitions of efforts, added materials, and a corresponding increase of job time. Hence, known approaches are not as easy, efficient, and less costly as they might otherwise be.

Also, forces arising between the dispensing tape and lip during dispensing tend to laterally shift or slide the two apart, thereby separating the tape and sheet material to make for a less secure joint than intended. In particular, it has been observed that the lip along a longitudinal edge on the coiled end of the sheet material is not firm in a radial dimension, but relatively radially compressible. During dispensing, the end of the less firm coiled sheet material may compress even more radially relative to the remaining portion of the coiled sheet. As a result, the tendency for a sliding or shifting that separates the tape from the lip in the tape application area is increased. Such outcomes are less than entirely desirable. Moreover, less firm end portions may also be susceptible to damage during shipping or handling as, for example, by a contractor. A less firm end portion makes lamination of the pressure sensitive tape to the film less effective. A poor seal between the pressure sensitive tape and the film may result in a separation between the film and tape when pressurized spray equipment is used, allowing the paint or coating to spread under the masked surface.

Moreover, some folded films have relatively thin coatings thereon. The folding process typically uses folding bars and the like that are stationary members and which serve to guide and fold the films passing in engagement therewith. Given the relatively high speeds of film transport and the intimate engagement with the folding bars, there is a tendency for scraping and removing of thin coatings on the masking sheet film.

Accordingly, there is an interest in inhibiting separation of a mounted and folded masking sheet material from an adhesive tape, after both have been applied to a wall surface, during an unfolding process, thereby minimizing heretofore known drawbacks associated with the separation during unfolding.

Accordingly, there is an interest in improving the joining and dispensing of the pressure sensitive adhesive tape to the coiled sheet material so as to minimize or eliminate any lateral sliding between the two.

### SUMMARY

The present disclosure is related to a folded roll of thin and flexible masking material having a longitudinal axis and first and second folded end portions axially spaced from each other along the longitudinal axis. The folded roll of masking material comprises: a coiled elongated generally tubular sheet including generally parallel and spaced apart first and second exterior pleated major surface portions which define first and second longitudinal edges; a first fold intermediate the first and second longitudinal edges for defining a first intermediate length and defining first and second portions of the first exterior pleated surface portion in a mutually facing and generally parallel relationship to each other. The first fold is adjacent the first folded end portion; and a second fold is defined intermediate the first intermediate length. As such this includes first and second portions of a second exterior pleated surface portion so that the first and second portions are in a mutually facing and generally parallel relationship to each other, wherein the second fold is adjacent the second folded end portion. A slit defines first and second elongated edges in an exteriorly disposed surface of another portion of the second exterior pleated surface portion that is adjacent the second folded end portion and which forms a radial portion of the second exterior pleated surface portion that extends and retains its position generally radially at the second end portion, and a first distal portion having one of the first and second elongate edges retained in a position which is generally axial of the longitudinal axis.

The present disclosure is related to a folded roll of thin and flexible masking material having a longitudinal axis and first and second folded end portions axially spaced from each other along the longitudinal axis. The folded roll of masking material comprises: a coiled elongated generally tubular sheet including generally parallel and spaced apart first and second exterior pleated major surface portions which define first and second longitudinal edges. A first fold is intermediate the first and second longitudinal edges for defining a first intermediate length and defining first and second portions of the first exterior pleated surface portion in a mutually facing and generally parallel relationship to each other, wherein the first fold is adjacent the first folded end portion. A second fold is defined intermediate the first intermediate length and defining first and second portions of a second exterior pleated surface portion so that the first and second portions are in a mutually facing and generally parallel relationship to each other, wherein the second fold is adjacent the second folded end portion; and a slit. The slit defines first and second elongated edges in an exteriorly disposed surface of another portion of the second exterior pleated surface portion that is adjacent the second folded end portion and which forms a radial portion of the second exterior pleated surface portion, and a first distal portion having one of the first and second elongate edges retained in a position which is generally axial of the longitudinal axis.

The present description is directed to a folded roll of thin and flexible masking material having a longitudinal axis and first and second folded end portions axially spaced from each other along the longitudinal axis. The folded roll of masking material comprises: a coiled elongated sheet including generally parallel and spaced apart first and second exterior pleated major surface portions which define first and second longitudinal edges; a first fold intermediate the first and second longitudinal edges for defining a first intermediate length and defining first and second portions of the first exterior pleated major surface portion in a mutually facing and generally parallel relationship to each other, wherein the first fold is adjacent the first folded end portion; a second fold defined intermediate the first intermediate length and defining first and second portions of a second exterior pleated major surface portion so that the first and second portions thereof are in a mutually facing and generally parallel relationship to each other, wherein the second fold is adjacent the second folded end portion; a slit defining first and second elongated edges in the second exterior pleated surface portion that is adjacent the second folded end portion, and a radial end portion, wherein a segment of the second folded portion is adherable to an adhesive surface of an adhesive tape, such that the radial end portion is secured to the adhesive surface; and the first folded portion and the first and second longitudinal edges are in generally overlying relationship to each other, such that the first and second longitudinal edges are in respective planes closer to the adhesive surface than a plane of the first folded portion.

The present disclosure is related to a dispensing system for joining and dispensing a roll of tape having an adhesive on one surface thereof and a folded roll of thin and flexible masking material in a combination of the adhesive tape. The system comprises: a roll of tape having an adhesive on one surface thereof and a folded roll of thin and flexible masking material having a longitudinal axis and first and second folded end portions axially spaced from each other along the longitudinal axis. The folded roll of masking material comprises a coiled elongated generally tubular sheet including generally parallel and spaced apart first and second exterior pleated major surface portions which define first and second longitudinal edges. A first fold is intermediate the first and second longitudinal edges for defining a first intermediate length and defining first and second portions of the first exterior pleated surface portion in a mutually facing and generally parallel relationship to each other. The first fold is adjacent the first folded end portion. A second fold is defined intermediate the first intermediate length and defining first and second portions of a second exterior pleated surface portion so that the first and second portions are in a mutually facing and generally parallel relationship to each other. The second fold is adjacent the second folded end portion. A slit defines first and second elongated edges in an exteriorly disposed surface of another portion of the second exterior pleated surface portion that is adjacent the second folded end portion and which forms a radial end portion of the second exterior pleated surface portion that extends and retains its position generally radially at the second end portion, and a first distal portion having one of the first and second elongate edges retained in a position which is generally axial of the longitudinal axis. Included in the system is a hand tool assembly being operable for joining and dispensing a combination of the roll of tape and the folded sheet material roll so that the tape is joined adjacent an end portion of the folded roll. The hand tool assembly includes a first rotatable assembly for dispensing the tape in response to being withdrawn therefrom, and a second rotatable assembly for dispensing the rolled masking material. The first and second rotatable assemblies are arranged such that the adhesive tape may be joined along a longitudinal edge of the rolled masking material as both are being withdrawn from their respective first and second rotatable assemblies; and a cutting tool for cutting the joined adhesive tape and rolled masking material.

The present description is directed to a process of unfolding a generally flat and folded flexible masking material having an adhesive strip adhesively secured along one edge of a longitudinal segment of an exterior surface of the folded masking material. The process comprises: providing a generally flat and folded elongated sheet including generally parallel and spaced apart first and second exterior pleated major surface portions which define first and second longitudinal edges; a first fold intermediate the first and second longitudinal edges for defining a first intermediate length and defining first and second portions of the first exterior pleated major surface portion in a mutually facing and generally parallel relationship to each other, wherein the first fold is adjacent a first folded end portion of the elongated sheet; a second fold intermediate the first intermediate length and defining first and second portions of a second exterior pleated surface portion so that the first and second portions thereof are in a mutually facing and generally parallel relationship to each other, wherein the second fold is adjacent a second folded end portion; a slit defining first and second elongated edges in the second exterior pleated surface portion that is adjacent the second folded end portion, and a radial end portion; the first folded portion and the first and second longitudinal edges are in generally overlying relationship to each other so; an adhesive strip having an adhesive surface adhesively attached to a segment of the second folded portion such that the radial end portion is secured to the adhesive surface and the first and second longitudinal edges are in respective planes closer to the adhesive surface than a plane of the first folded portion; and unfolding the first and second folded portions by applying a pulling force in a first direction on sheet segments of the first folded portion adjacent the first folded end portion so that the first and second elongated edges are separated relative to the first direction and the second folded portion unfolds in the first direction prior to unfolding of the first folded portion, and the second longitudinal edge unfolds in the first direction prior to unfolding of the first longitudinal edge such that unfolding sheet segments of the first folded portion move in the first direction relative to stationary sheet segments of the second longitudinal edge attached to the adhesive strip, whereby direct unfolding pulling forces in the first direction are not directly applied to the stationary sheet segments.

The present description is directed to a process of making a folded roll of thin and flexible masking material having a longitudinal axis and first and second folded end portions axially spaced from each other along the longitudinal axis. The process comprises: providing a coiled elongated sheet including generally parallel and spaced apart first and second exterior pleated major surface portions which define first and second longitudinal edges; folding the elongated sheet intermediate the first and second longitudinal edges for defining a first intermediate length and defining first and second portions of the first exterior pleated surface portion in a mutually facing and generally parallel relationship to each other, wherein the first fold is adjacent the first folded end portion; folding the first intermediate length to define a second folded end portion having first and second portions of a second exterior pleated surface portion so as to be in a mutually facing and generally parallel relationship to each other, wherein the second fold is adjacent the second folded end portion; and providing a slit in the second exterior pleated major surfaces for defining first and second elongated edges therein and a radial end portion, so that a segment of the second folded portion is adherable to an adhesive surface of an adhesive tape, whereby the radial end portion is attachable to the adhesive surface, and the first folded portion and the first and second longitudinal edges are in generally overlying relationship to each other, such that the first and second longitudinal edges are in respective planes closer to an adhesive surface of the adhesive tape than a plane of the first folded portion.

The present disclosure is related to a dispensing system for joining and dispensing a roll of tape having an adhesive on one surface thereof and a folded roll of thin and flexible masking material in a combination of the adhesive tape along an edge of the folded roll, the system comprising: a roll of tape having an adhesive on one surface thereof; a folded roll of masking material comprising: a coiled elongated sheet including generally parallel and spaced apart first and second exterior pleated major surface portions which define first and second longitudinal edges; a first fold intermediate the first and second longitudinal edges for defining a first intermediate length and defining first and second portions of the first exterior pleated major surface portion in a mutually facing and generally parallel relationship to each other, wherein the first fold is adjacent the first folded end portion; a second fold defined intermediate the first intermediate length and defining first and second portions of a second exterior pleated major surface portion so that the first and second portions thereof are in a mutually facing and generally parallel relationship to each other, wherein the second fold is adjacent the second folded end portion; a slit defining first and second elongated edges in the second exterior pleated surface portion that is adjacent the second folded end portion, and a radial end portion, wherein a segment of the second folded portion is adherable to an adhesive surface of an adhesive tape, such that the radial end portion is secured to the adhesive surface; and the first folded portion and the first and second longitudinal edges are in generally overlying relationship to each other, such that the first and second longitudinal edges are in respective planes closer to the adhesive surface than a plane of the first folded portion.

One aspect of the present application is to provide a coiled sheet of material that improves dispensing an adhesive coated tape and a folded flexible sheet material that are mutually engaging along adjacent longitudinal edges.

Another aspect of the present application is to provide a coiled sheet of material that includes a folded configuration that provides firm longitudinal ends portions.

Another aspect of the present application is to provide a coiled sheet of material that includes a folded configuration that provides a firm longitudinal end portion which tends to eliminate or minimize the likelihood of sliding of the coiled sheet of material under the adhesive tape during dispensing.

Another aspect of the present application is a folded configuration that enables fabrication of rolls with multiple folds closer to the longitudinal edges, thereby resulting in a relatively less compressible and firmer edge.

Another aspect of the present application is to provide a coiled sheet of material that facilitates unfolding or unfolding while it is suspended by the adhesive tape secured to a wall. Another aspect of the present application is to provide a coiled sheet of material that is folded to not only achieve the foregoing aspects, but do so in a manner whereby the pulling forces during unfolding or unfolding are not directly transmitted to the tape during unfolding.

Another aspect of the present application is a folded configuration that enables formation of rolls that have end portions with lessened susceptibility to damage during shipping or handling by a user.

Another aspect of the present application is a folded configuration in a coiled sheet that enables formation of rolls that have improved tape tracking and allow for the use of higher unwinding rates for tapes.

Another aspect of the present application is a folded configuration in a coiled sheet that enables the formation of rolls that create an improved seal between the tape and the film during application.

Another aspect of the present application is a folded configuration that enables formation of rolls that have multiple folds located near the edge and within close proximity of each other that retains the multiple folds in such a manner that they are protected and less likely to get stuck under the tape.

Another aspect of the present application is a folded configuration that enables formation of rolls with multiple folds that pull away from the taped edge as a unit, thereby reducing or eliminating the possibility that film folds will get stuck under the tape.

Another aspect of the present application is a folded configuration that enables formation of rolls having multiple folds wherein provision is made for a distal end portion or lip that does not unfold and cover the surface of the adhesive on the adhesive tape during application of the latter.

Another aspect of the present application is a folded configuration that enables formation of rolls having multiple folds wherein the distal end portion is relatively short for purposes minimizing the distal end portion flipping onto and covering a significant portion of adhesive on the tape.

The aspects described herein are merely a few of the several that can be achieved by using the present description. The foregoing descriptions thereof do not suggest that the present description must only be utilized in a specific manner to attain the foregoing aspects.

### BRIEF DESCRIPTION OF THE DRAWINGS

FIG. 1 is a perspective view of a portable tape and sheet dispensing apparatus for joining and dispensing a roll of a pressure sensitive adhesive tape and a sheet of flexible sheet material.

FIGS. 2-3 illustrate a draping and unfolding sequence of a folded sheet material and pressure sensitive tape combination being attached to a wall structure or the like.

FIG. 4 is a schematic view of one of the exemplary embodiment for making a folded construction according to the present description.

FIG. 5 is a schematic view of one exemplary embodiment of a generally tubular portion of a sheet material construction.

FIG. 6 is a schematic view of the tubular sheet material of FIG. 5 being folded a first time.

FIG. 7 is a schematic view of the folded sheet material of FIG. 6 being folded a second time according to the present description.

FIG. 8 is a schematic view of a folded sheet material having been slit and joined to an edge of a masking tape material.

FIG. 9 is a schematic view of another exemplary embodiment of a folding system for making a coiled folded construction according to the present description.

FIG. 10 is a schematic view of the tubular sheet material of FIG. 5 being folded a first time.

FIG. 11 is a schematic view of the folded sheet material of FIG. 10 being folded a second time according to the present description.

FIG. 12 is a schematic view of folded sheet material having been slit and joined to an edge of a masking tape.

FIG. 13 is a schematic view of a folded sheet material having been slit whereby a flap portion unfolds and is joined to an edge of a masking tape.

FIG. 14 is a schematic view of another exemplary embodiment of a folding system for making a folded construction according to the present description.

FIG. 15 is a schematic view of another exemplary embodiment of a sheet material construction having a slit.

FIG. 16 is a schematic view of a sheet material of FIG. 15 being folded a first time.

FIG. 17 is a schematic view of the folded sheet material of FIG. 16 being folded a second time according to the present description.

FIG. 18 is a schematic view of the folded sheet material having been slit and joined to an edge of a masking tape.

FIG. 19 is a perspective view of a slitting and retaining mechanism according to the present description.

FIG. 20 is an exploded perspective view of the slitting and retaining mechanism of FIG. 19.

FIG. 21 is a plan view of a tubular folding bar utilizable in folding the sheet material and a source of pressurized air.

FIG. 22 is cross-sectional view taken along section line 22-22 in FIG. 21.

FIG. 23 is a schematic cross-sectional view of a known folded masking sheet material joined to an adhesive tape prior to being unfolded.

FIG. 24 is a schematic view of a partial unfolding of the folded sheet material of FIG. 23.

FIG. 25 is a schematic view illustrating a partial unfolding of the folded sheet material illustrated in FIG. 8.

FIG. 26 is a schematic view illustrating a further unfolded condition of the folded sheet material illustrated in FIG. 25.

### DETAILED DESCRIPTION

According to the present description, provisions are made to improve upon the above noted drawbacks and shortcomings of folded masking sheet materials for use in joining to masking tape in a dispensing system.

The words “a,” “an,” and “the” are used interchangeably with “at least one” to mean one or more of the elements being described. By using words of orientation, such as “top,” “bottom,” “overlying,” “front,” and “back” and the like for the location of various elements in the disclosed articles, we refer to the relative position of an element with respect to a horizontally-disposed body portion.

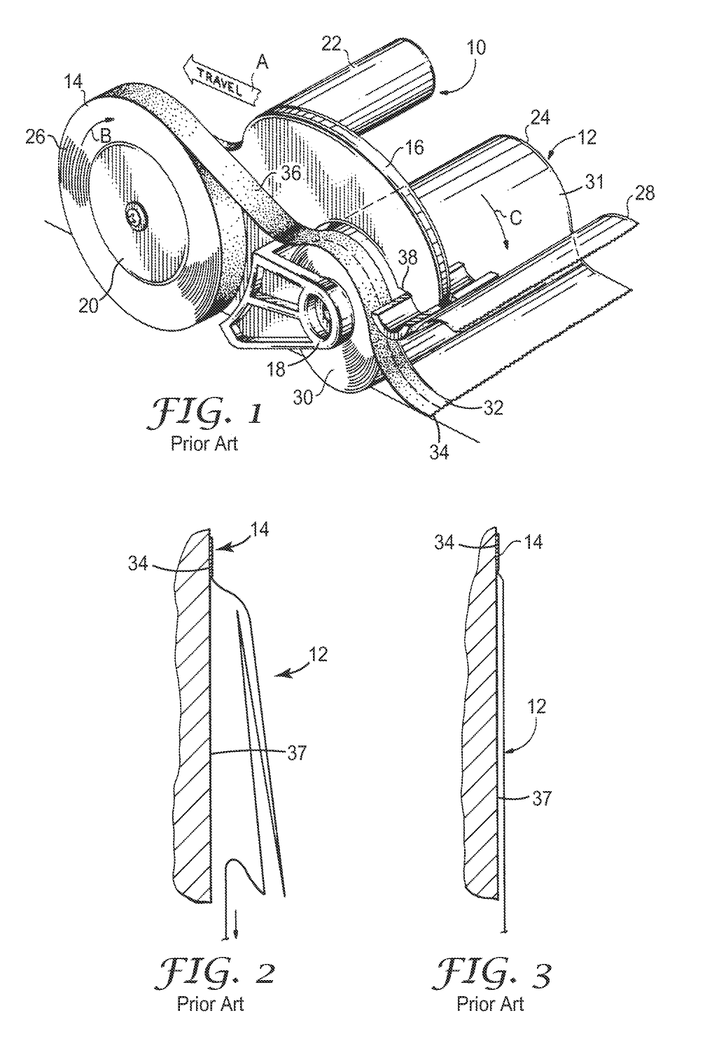

Reference is made to FIG. 1 which illustrates one exemplary embodiment of a portable tape and sheet dispensing apparatus 10 for joining and dispensing a sheet material 12 and a pressure sensitive adhesive masking tape 14. It will be appreciated that the dispensing apparatus 10 may be a portable or manually manipulatable type. For example, the dispensing apparatus 10 may be similar to that described in commonly assigned U.S. Pat. No. 5,113,921, which is incorporated herein and made a part hereof. It will be understood that the present description envisions other similar types of portable dispensing apparatus. Also, the joining and dispensing may be performed by stationary devices, such as an apron taper or the like. Since the dispensing apparatus 10 is similar to the one described in the foregoing patent, only those portions thereof related to the present description will be described herein.

The dispensing apparatus 10 includes a frame 16 having a first holder 18, a second holder 20, and a handle 22. The first and second holders 18, 20 are rotatable spindles for supporting a roll 24 of coiled sheet material 12 and a roll 26 of masking tape 14. A cutting blade 28 is carried by the frame 16. The roll 24 of coiled sheet material 12 is mounted on the first holder 18 and the roll 26 of masking tape 14 is mounted on the second holder 20. The roll 24 of the coiled sheet material 12 includes a first end portion 30 and a second end portion 31. The width of the roll 24 (i.e., distance between the longitudinal ends) generally corresponds to the length of the cutting blade.

At least an overlap portion 32 of a ribbon 36 of the masking tape 14 being dispensed from the roll during operation of the dispensing apparatus 10 extends over and is joined to a longitudinal edge of the of the sheet material 12 being unwound from the roll 24. A tape application area 34 adjacent the overlap portion 32 remains free to be affixed to a wall surface or the like to be masked (see FIGS. 2 & 3). As will be described, the fold configuration of the present description enables the overlap portion 32 to maintain a consistent spacing relationship as it is unwound since it minimizes the likelihood of the sheet material sliding under the tape during dispensing. As such, as the apparatus 10 is moved in the direction indicated by the arrowed line A, the masking material 12 and the masking tape 14 are progressively unwound and joined for dispensing. The direction of unwinding or uncoiling are designated by arrows B and C, respectively. The exposed surface of the tape 14 along the tape application area 34 is continuously being affixed to a wall surface 37 either by manual pressure or by an applicator 38 integral with the frame 12. When a desired length of the combined sheet material and masking tape has been dispensed, the cutting blade 28 may be used to sever both the tape and the masking sheet in a known manner.

FIGS. 2 and 3 illustrate the joining of the combined sheet material 12 and masking tape 14 and along to a wall surface 37 and being unfolded and draped in usual fashion.

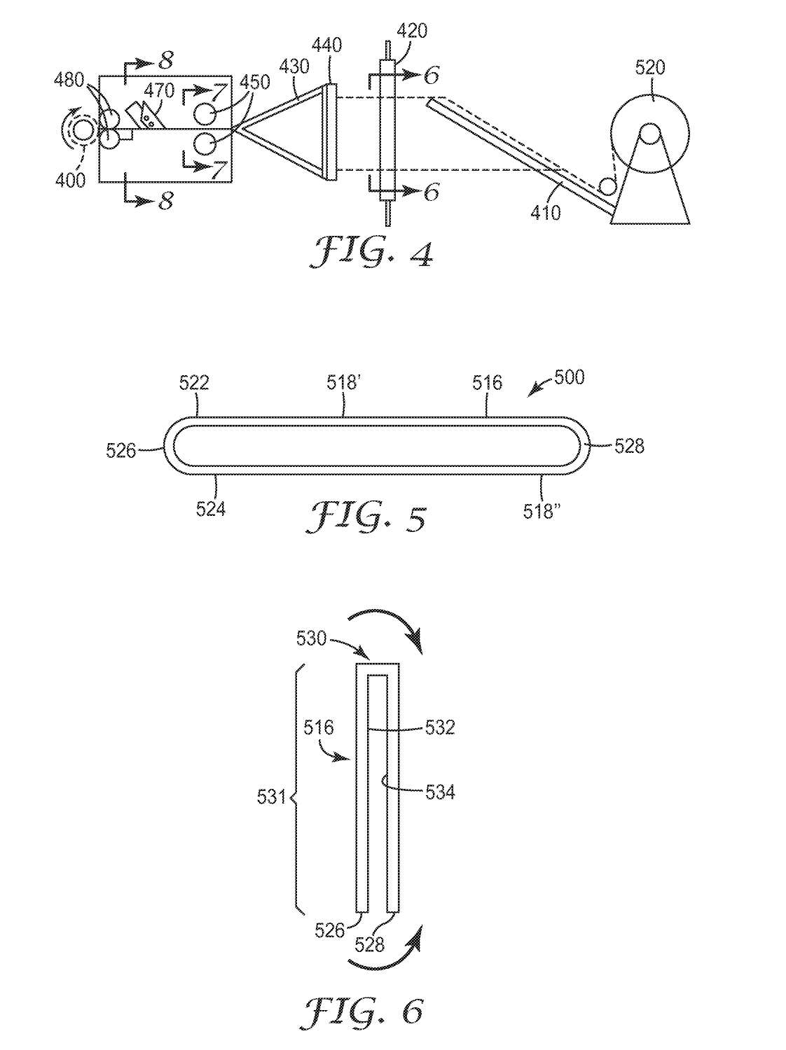

Reference is made to FIGS. 4-8 for illustrating one exemplary embodiment of a folded masking sheet material 800 of thin and flexible masking material of the kind noted above. The folded masking sheet material 800 is illustrated in FIG. 8 and a process of making the same is illustrated in FIGS. 4-7 so as to coil the same into a roll 400 (FIG. 4) of folded sheet material.

The folded masking sheet material 800 starts from a thin and flexible sheet of masking material 500 (FIG. 5) having a generally tubular, flattened, and non-folded tubular body construction 516 with generally parallel layers 518′ and 518″, respectively. The tubular body construction 516 is unwrapped from a roll 520 (see FIG. 4) thereof and has a length and width sufficient to make roll 400 (see FIG. 4) according to known consideration in this field. For example, the width of the roll 400 may vary from about 8 to about 72 inches or from about 20.32 centimeters to about 182.88 centimeters wide. This range is merely illustrative and not limiting. The layers 518′ and 518″ of the tubular body construction 516 define a first exterior pleated major surface 522 and a second exterior pleated major surface 524, respectively. The tubular body construction 516 also includes first and second longitudinal edges 526 and 528, respectively.

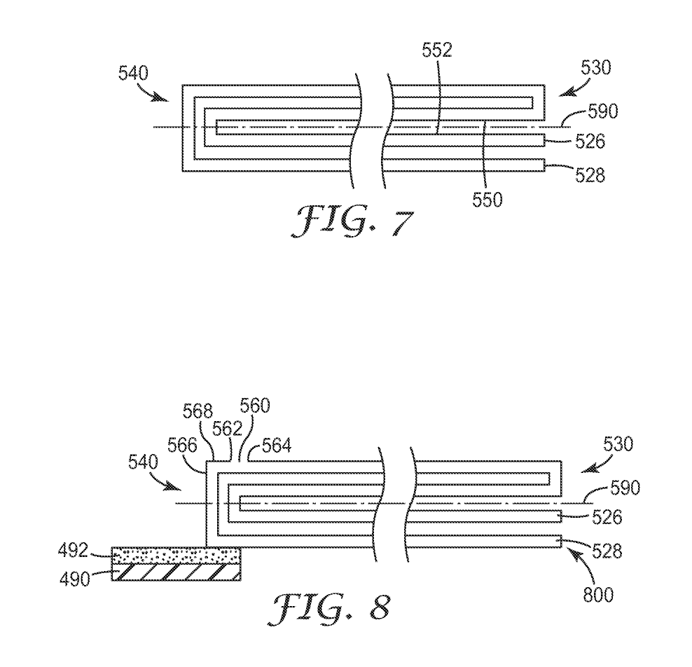

As illustrated in FIG. 6, the tubular body construction 516 has been folded to define a first folded portion 530 with the first and second longitudinal edges 526 and 528 terminating at about the same distance from the first folded portion 530. Essentially, the body construction 516 was folded in half, but this fold may be located elsewhere intermediate the tube. Such a folded configuration defines a first intermediate length 531 having mutually facing first and second portions 532 and 534, respectively, of the first exterior pleated major surface 524. Such a folding operation may take place by advancing a web from the roll 520 over folding bars having a relatively large diameter of a folding plow structure 410 (FIG. 4) as is known, into a pair of rotatably driven nip rollers 420. The folding plow structure may have a configuration as described hereinafter. The nip rollers 420 operate to crease and fold the unfolded web of the tubular body construction 516 as well as hold the web against the plow. Other known and suitable folding devices may be used to perform this operation.

As illustrated in FIG. 7, the tubular body construction 516 has again been folded to define a second folded portion 540 that defines a longitudinal end of the folded masking sheet material 800 (FIG. 8) that is opposite the first folded portion 530. The first folded portion 540 is formed by folding the first intermediate length, such as at a second exterior pleated major surface to make the folded masking sheet material 800 (see FIG. 8). As a result, first and second portions 550 and 552, respectively, of the second exterior pleated major surface are mutually facing each other. In addition, the first folded portion 530 is located so at to be positioned over the first and second longitudinal edges 526 and 528.

Reference is made back to FIG. 4 for describing formation of the second folded portion 540. The second fold may occur following the web passing the nip rollers 420 and being folded by a second folding plow structure 430 that may be similar in construction. Another roller 440 urges the web exiting the nip rollers 420 into engagement with the second folding plow structure 430. Other known and suitable folding devices may be used to perform the foregoing operation consistent with the present description. The second folding plow structure 430 is oriented in a different manner, as illustrated, to perform the second folding operation. A pair of rotatably driven nip rollers 450, that effectuate the second folded portion 540 is downstream of the second folding plow structure and upstream of the roll 400. Also, provision may be made for a slitting and retaining mechanism 470 downstream of the nip rollers 450. The slitting and retaining mechanism 470 is operable for providing a slit 560.

In FIG. 8, the folded masking sheet material 800 has the slit 560 in a top layer, as viewed in the drawing, of the folded construction adjacent the second folded end portion 540. The slit 560 defines first and second elongated edges 562 and 564, respectively that according to this embodiment may be retained to be generally parallel to the longitudinal axis as illustrated in FIG. 8. A radially extending end portion 566 has a distal end portion 568 that includes the first elongated edge 562 retained in the illustrated position. Advantageously, by keeping the distal end portion 568 retained, as shown, the folds tend to remain sheathed during shipping and storage. As a consequence, a coiled sheet of material may be provided that includes a folded configuration that provides firm longitudinal ends portions which tend to eliminate or minimize the likelihood of sliding of the coiled sheet of material under the adhesive tape during dispensing. In addition, the resulting folded configuration enables fabrication of rolls with multiple folds closer to the longitudinal edges, thereby resulting in a relatively less compressible and firmer edge. This makes the rolls with lessened susceptibility to damage during shipping or handling by a user as well as improves tape tracking and allow for the use of higher unwinding rates for tapes and an improved seal between the tape and the film. It is highly advantageous in that the present description enables formation rolls having distal end portions being less than ⅜ inch long and may even as small as ⅛ inch or less. The reduced size enables formations that minimize or eliminate covering appreciable portion of an adhesive tape during application. In addition, the folded configuration enables formation of rolls with multiple folds that pull away from the taped edge as a unit, thereby eliminating the possibility that the film folds will get stuck under the tape.

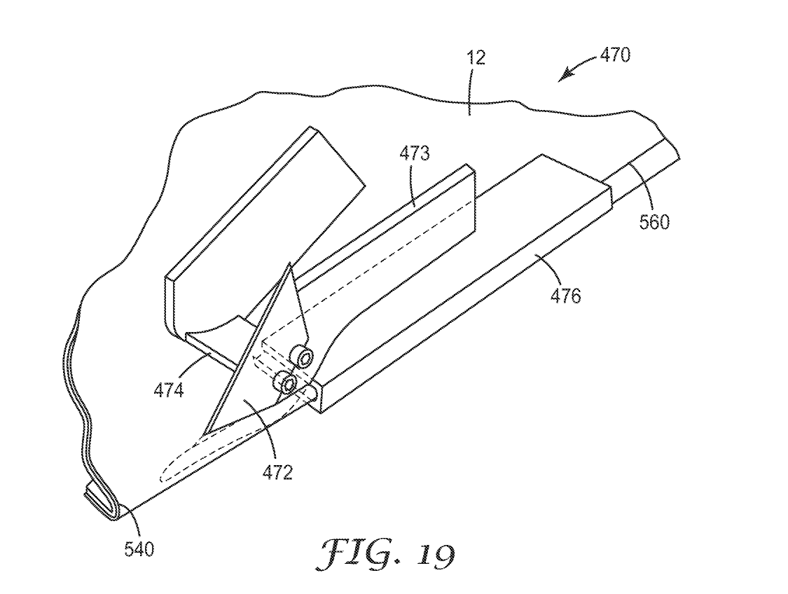

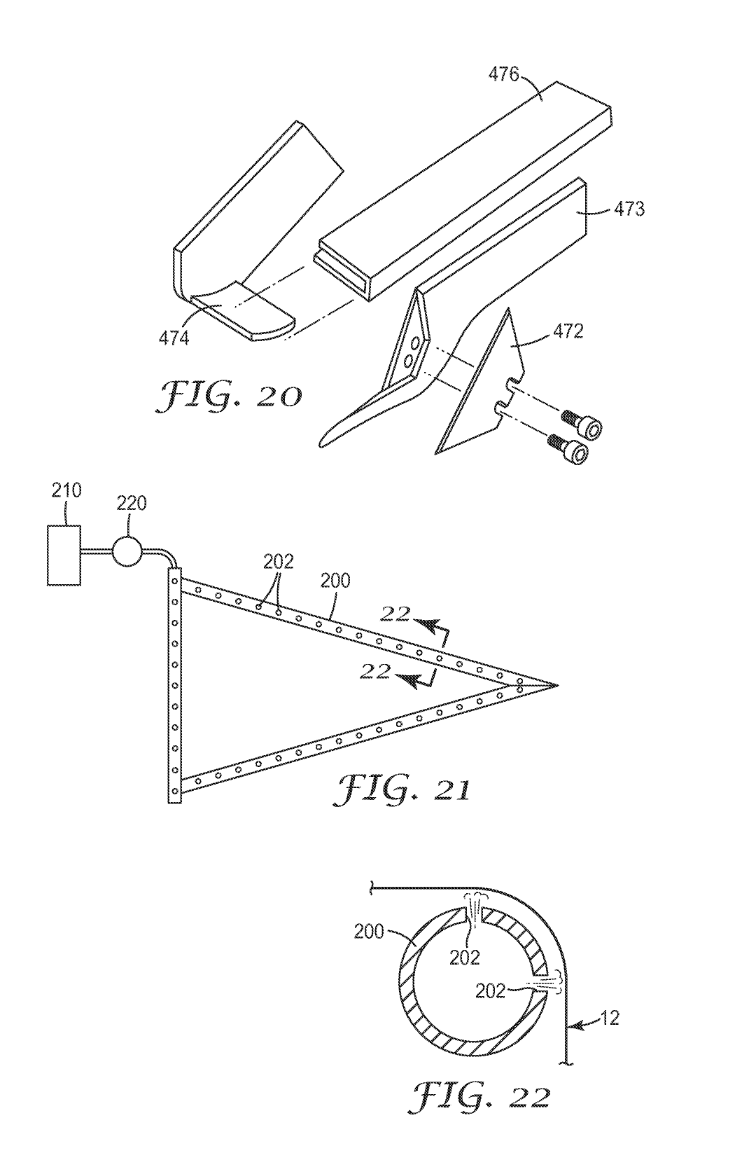

To make the slit 560 and to retain the radially extending end portion 566, the double folded tubular body construction 516 passes through a slitting and retaining mechanism 470. As seen in FIGS. 19 and 20 , the slitting and retaining mechanism 470 includes a cutting blade 472 held by a blade holder 473, laterally extending foot portion 474 and a retaining element 476 in the form of a generally U-shaped channel member 476. The cutting blade 472 is held to cut the slit, thereby defining the first and second elongated edges. Generally contemporaneously with the slitting operation there occurs a compressing operation on the folded end by the foot portion 474. Following the pressing and slitting, the channel member 476 serves to retain the compressed and slit second folded end portion, whereby the radially extending end portion does not flip over, but rather covers the second end portion in a sheathing relationship. As a result, this makes slitting easier and facilitates retaining the radially extending end portion 566 and the distal end portion 568 in the illustrated positions (see FIG. 8). Following the slitting and retaining, another pair of driven nip rollers 480 advances the web of folded material onto a spindle to form the roll 400 in a known manner. Also, as illustrated, the adhesive tape 490 having an adhesive surface 492 will be joined to the folded construction during dispensing from the dispensing apparatus.

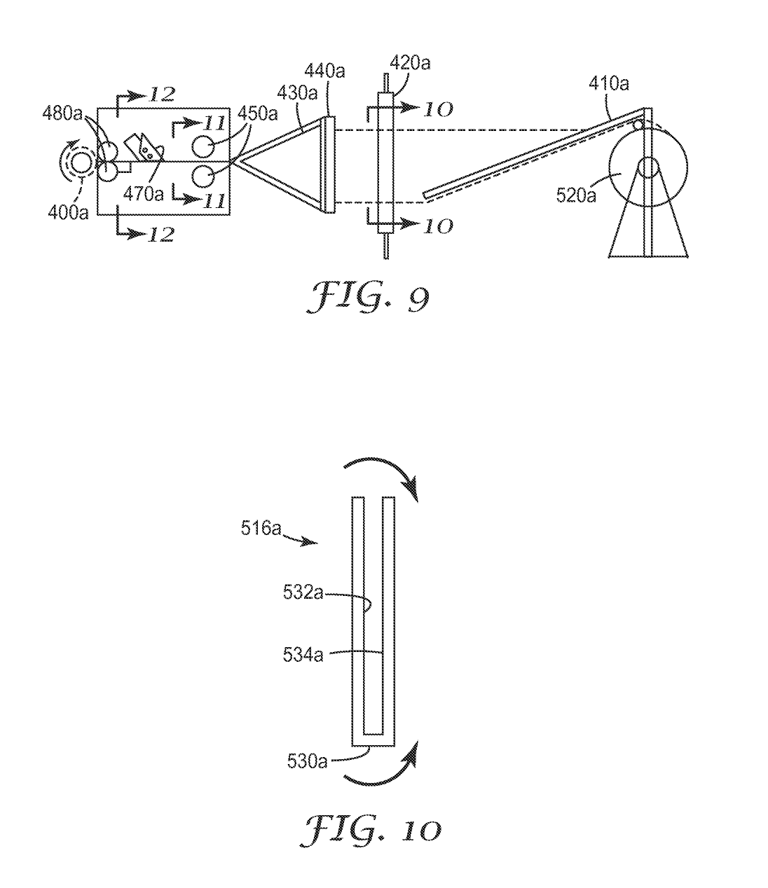

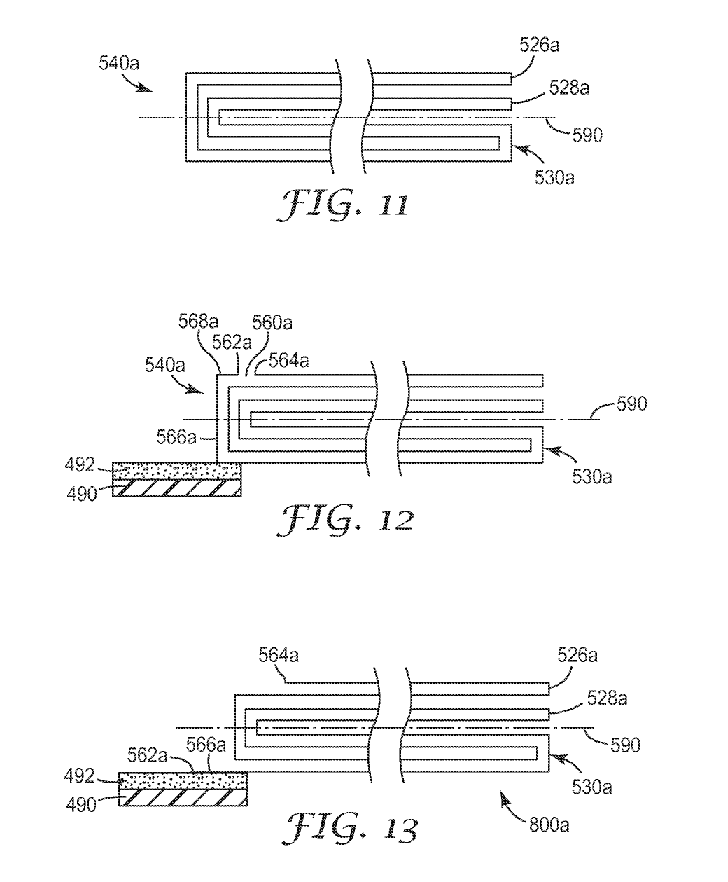

Reference is made to FIGS. 9-13 for illustrating another exemplary embodiment of the present description which is similar to the previous embodiment. Accordingly, similar structure of the present embodiment will be designated with the same reference numeral but with the addition a suffix marking “a”. As illustrated in FIG. 13 one difference is that the radially extending end portion 566a and the distal end portion 568a are allowed to flip open after being slit by the slitting mechanism. Flipping is allowed since the radially extending end portion 566a and the distal end portion 568a are not retained in their illustrated position (see FIG. 8) because no retaining function is being performed. Rather, only a slitting function need be accomplished. Hence, the radially extending end portion 566a and the distal end portion 568a extend in a direction which is generally parallel with the longitudinal axis 590 of the roll. Flipping is achieved because of the inherent flimsy nature of these thin elements.

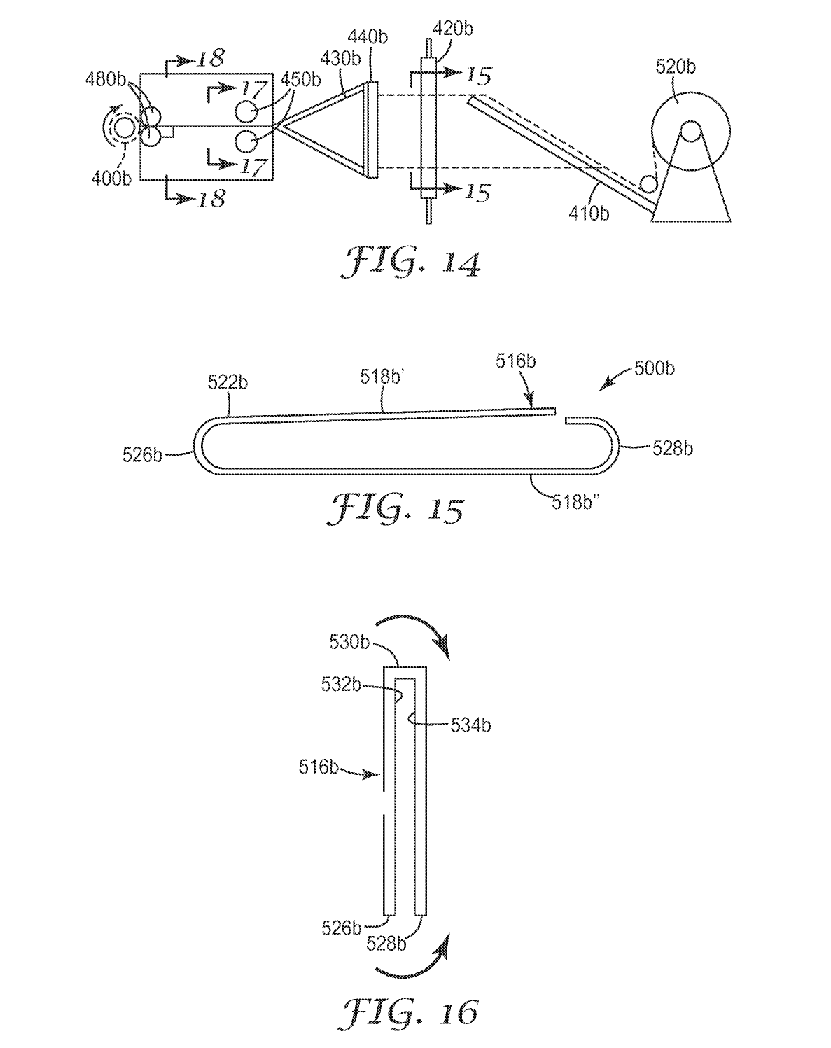

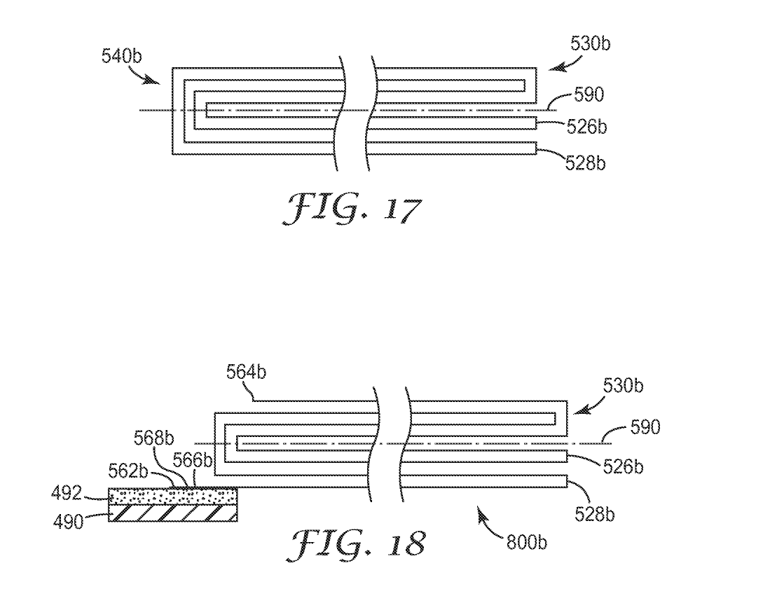

Reference is made to FIGS. 14-18 for illustrating another exemplary embodiment of the present description which is similar to the previous embodiment. Accordingly, similar structure of the present embodiment will be designated with the same reference numeral but with the addition a suffix marking “b”. As illustrated in FIG. 18, one difference is that the radially extending end portion 566b and the distal end portion 568b are allowed to flip open after being folded. The slitting may occur before folding. Flipping is allowed since the radially extending end portion 566b and the distal end portion 568b are not retained in their illustrated position (see FIG. 8) because no retaining function is being performed. Rather, only a slitting function need be accomplished as noted above. Hence, the radially extending end portion 566b and the distal end portion 568b extend in a direction which is generally parallel with the longitudinal axis 590 of the roll. Flipping is achieved because of the inherent flimsy nature of these thin elements. In this embodiment, there is no slitting since a slit has already been formed in the tubular sheet construction before folding. Also, the tubular sheet may start out as a flat sheet that is folded in a known manner to assume a tubular configuration with its end portions separated as a slit, as illustrated in FIG. 15, thereby resembling a tubular formation that has a slit. The equipment in the process is similar as well and it too is designated by similar reference numerals, but with the addition of the suffix “b”. In this process, there is no need for the slitting and retaining mechanism.

Reference is made now to FIGS. 21 and 22 for illustrating a pressurized folding bar having a large diameter tube. The pressurized folding bar 200 of the exemplary embodiment has an enlarged radius having a plurality of openings 202 spaced apart and extending along two circumferentially spaced apart rows. The rows extend along at least a portion of the folding bar 200 that the sheet material would be wrapped. As a result of pressurized air issuing from the openings 202, the advancing web of sheet material is suspended away from engagement with the folding bars. The degree of suspension is such as to allow the folding to continue, but avoid engagement that would serve to scratch or remove any thin coating or the like on the advancing web. The pressure is directed into the tube by a source 210 of pressurized air that is under control of an air regulator 220. The pressurized air may have a pressure selected in accordance with the web tension to insure movement of the latter at a desired speed and web suspension. While this approach is illustrated, it will be appreciated that changes may be made for the foregoing.

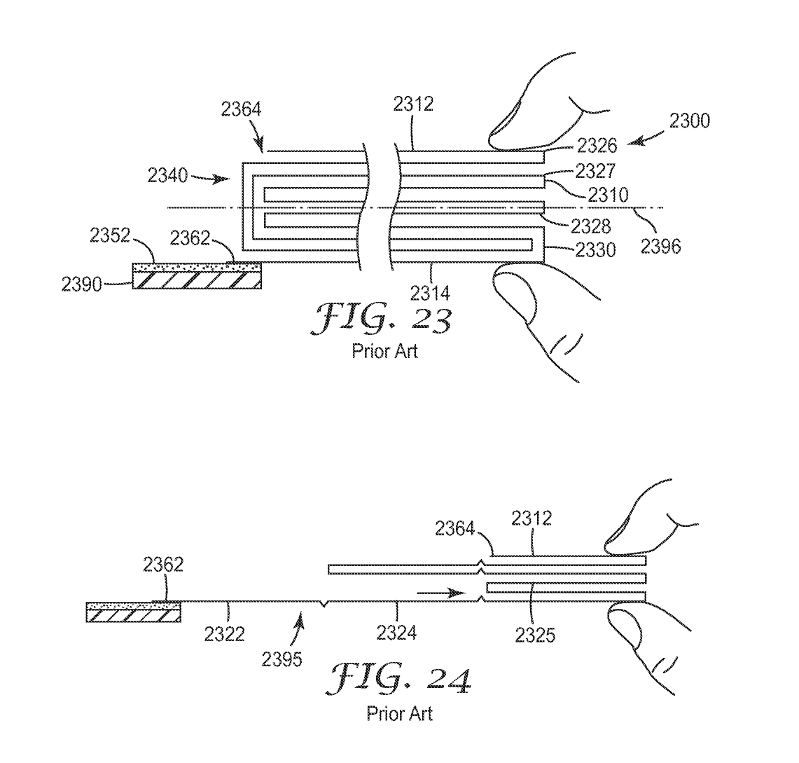

Reference is made to FIG. 23 for illustrating a known prior art kind of folded masking sheet material 2300 that is similar to the kinds described in commonly-assigned U.S. Pat. No. 5,113,921. This embodiment of the roll of folded masking sheet material 2300 includes at least one gusset 2310 or pleated portion 2310 that is sandwiched between the outermost layers 2312 and 2314 as illustrated. Alternatively, a plurality of gussets (not shown) may be utilized instead of a single gusset. The illustrated gusset 2310 comprises a longitudinal end fold 2327 and a pair of opposing and longitudinally extending pleated major surfaces that are generally parallel to a longitudinal extending axis 2396 of the roll. Also, the radial end portion of the longitudinal end fold 2327 of the gusset 2310 may be generally radially aligned with the other radial end portions of the folds 2326, 2328 as illustrated.

A folded portion 2340 of the roll masking sheet material 2300 is adhesively bonded to and along at least a surface of an adhesive layer 2392 of an adhesive tape 2390, as is illustrated. The end portion 2340 may terminate on the adhesive layer 2392 at a variety of other positions for reasons described above. It will be noted that the first and second longitudinal edges or leg portions 2326 and 2328, respectively, as well as the gusset 2310 are disposed so as to face inwardly toward a wall (not shown, upon which the adhesive layer is adhered.

Reference is now also made to FIG. 24 in combination with FIG. 23 for illustrating a partial unfolding of the roll of folded masking sheet material 2300. Towards this end, a user may initially grasp or slightly pinch, with their fingers, as illustrated in FIG. 23, the first fold portion 2330 of the roll of folded masking sheet material 2300. The end portion 2330 is typically the free end portion of the masking sheet material that is suspended from the wall. It will be seen that a finger tends to remain in contact with the surface of the outermost layer 2312. The thumb (lower finger) also grabs and pulls downwardly, but its position on the masking sheet material moves or slides relative to the folds during unfolding as will be explained. It will also be understood that the user pulls with sufficient force to bring about complete unfolding.

With continued reference to FIG. 24, it will be appreciated that as the user unfolds the roll of masking material, the first and second pleated major surfaces 2322 and 2324 are unfolded along with a pleated major surface 2325 of the gusset 2310. The thumb tends to slide along the length of the masking sheet material as it moves from the position illustrated in FIG. 23 to the position illustrated in FIG. 24. The first and second pleated major surfaces 2322, 2324 as well as the pleated major surface of the gusset 2310 when unfolded form unfolded segments 2395 that remain relatively stationary and directly affixed to the adhesive layer during unfolding. As a consequence, the pulling or tensioning forces are directly applied to and through the unfolded segments 2395 and to the adhesive interface with the adhesive layer 2392. Accordingly, there is a likelihood of separation of the unfolding roll of masking sheet material 2300 from the adhesive layer because the pulling forces are directly applied to the joint interface. This separation likelihood increases as more of the folds are unfolded and the adhesive joint is subjected to continued tensioning or pulling forces. Hence, there is a likelihood of having the masking sheet pulled from the wall following its attachment.

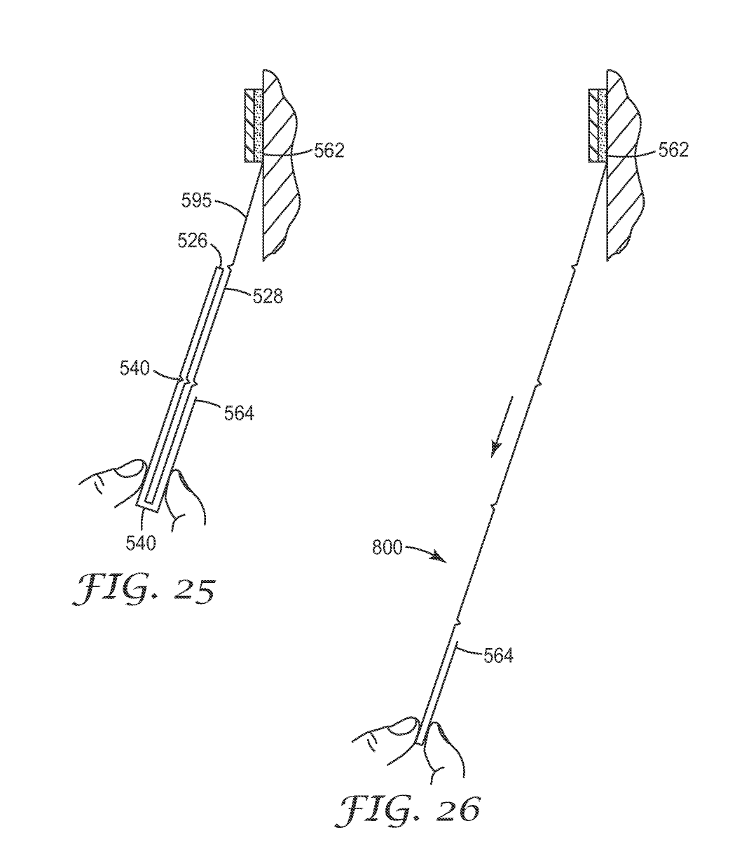

Reference is now made to FIGS. 25-26 taken along with FIG. 8 for illustrating one exemplary embodiment of the present description which facilitates unfolding of the folded masking sheet material in a manner that further minimizes a likelihood of the masking sheet and the adhesive tape being separated during unfolding. In this exemplary embodiment, the folded masking sheet of FIG. 8 is specifically arranged to have its first and second longitudinal edges 526 and 528 outwardly disposed when adhered to the adhesive strip that is secured to the wall. This is in contrast to the previous embodiment described in FIGS. 23-24.

Reference is made in particular to FIG. 25 for illustrating the advantages of unfolding using the fold pattern of the present description. During unfolding a user may grasp the folded masking sheet material 800 of FIG. 8 and pull. The pulling force will act to sequentially unfold the folded portions. In the present exemplary embodiment, the first and second elongated edges 562 and 564 will become separated as illustrated. As this occurs, the second folded end portion 528 has been unfolded while the first folded end portion 526 remains folded. Owing to the present folded pattern the rightward finger (as viewed in FIG. 25) may remain in contact with a portion 564 of the first exterior pleated major surface 524 during unfolding. Also, owing to the present fold construction, the thumb (leftward finger—as viewed in FIG. 25) will not, as in the previous embodiment, engage the unfolded relatively stationary portion or segment 595 that is directly affixed to the adhesive layer. Rather, the thumb may engage different sections of the folded construction during unfolding until it assumes the position indicated in FIG. 26. As illustrated, the thumb engages adjacent the radial end portion of the first fold 530. As such, the pulling forces are directed to unfolding the folds rather than pulling directly on an unfolded segment 595. Consequently, there is less of a tendency to separate the sheet from the adhesive layer and thus the wall.

This invention may take on various modifications and alterations without departing from the spirit and scope. Accordingly, this invention is not limited to the above-described embodiments, but is to be controlled by limitations set forth in the following claims and any equivalents thereof. This invention also may be suitably practiced in the absence of any element not specifically disclosed herein. All patents and publications noted above, including any in the Background section are incorporated by reference into this document in total.

What is claimed is:

1. A folded roll of thin and flexible masking material having a longitudinal axis and first and second folded end portions axially spaced from each other along the longitudinal axis, the folded roll of masking material comprising:
opposing, first and second outermost layers extending in a direction of the longitudinal axis between the first and second folded end portions;
a slit formed in the first outermost layer, the slit defining first and second elongated edges in the first outermost layer;
a first radially extending end portion extending between the first and second outermost layers at the first folded end portion;
a first intermediate layer immediately adjacent the second outermost layer, the first intermediate layer and the second outermost layer directly connected at a first fold formed at the second folded end portion;
a second intermediate layer immediately adjacent the first outermost layer; and
a third intermediate layer disposed between the first and second intermediate layers, the third intermediate layer directly connected to the first outermost layer at a second radially extending end portion at the second folded end portion;
wherein the second intermediate layer is longitudinally between the first and second radially extending end portions.

2. The folded roll of claim 1, further comprising a third radially extending end portion interconnecting the first and second intermediate layers adjacent the first folded end portion.

3. The folded roll of claim 2, wherein the third radially extending portion is longitudinally between the first radially extending end portion and the second folded end portion.

4. The folded roll of claim 3, further comprising a fourth intermediate layer disposed between the second and third intermediate layers, the second intermediate layer directly connected to the fourth intermediate layer at a second fold adjacent the second folded end portion, the second fold being located longitudinally between the first and second radially extending portions.
